(19) United States
(12) Patent Application Publication
(10) Pub. No.: US 2024/0405281 A1
(43) Pub. Date: Dec. 5, 2024

(54) Rechargeable Divalent Metal Batteries Having Fast Interfacial Charge Transfer Kinetics

(71) Applicant: University of Maryland, College Park, College Park, MD (US)

(72) Inventors: Chunsheng WANG, Silver Spring, MD (US); Singyuk HOU, Hanover, MD (US); Xiao JI, College Park, MD (US)

(73) Assignee: University of Maryland, College Park, College Park, MD (US)

(21) Appl. No.: 18/698,265

(22) PCT Filed: Oct. 3, 2022
(86) PCT No.: PCT/US22/45570

§ 371 Date: Apr. 3, 2024

Related U.S. Application Data
(60) Provisional application No. 63/262,130, filed on Oct. 5, 2021.

(51) Int. Cl. H01M 10/0567; H01M 4/02; H01M 4/38; H01M 4/42

(52) U.S. Cl. CPC H01M 10/0567; H01M 4/381; H01M 4/42; H01M 2004/027; H01M 2004/028

(57) ABSTRACT

The present disclosure provides rechargeable divalent metal batteries comprising a multidentate compound. In particular, the presence of a multidentate compound in the electrolyte of the rechargeable divalent metal batteries significantly increases the interfacial charge transfer kinetics and/or suppresses undesired side reactions on both cathodes and metal anodes. It is believed that these effects are at least in part due to solvation sheath reorganization by the multidentate compound. Other aspects of the disclosure include methods for reducing a charge transfer overpotential and methods for increasing a charge transfer kinetics in rechargeable divalent metal batteries.

### CROSS-REFERENCE TO RELATED APPLICATION(S)

This application claims the priority to U.S. Provisional Application No. 63/262,130, filed Oct. 5, 2021, which is hereby incorporated by reference in its entirety.

### STATEMENT REGARDING FEDERALLY FUNDED RESEARCH

This invention was made with government support under DEEE0008202 awarded by the U.S. Department of Energy (DOE). The government has certain rights in the invention.

### FIELD

The present disclosure relates to rechargeable divalent metal batteries comprising a multidentate compound. Other aspects of the disclosure include methods for reducing a charge transfer overpotential and methods for increasing a charge transfer kinetics in rechargeable divalent metal batteries.

### BACKGROUND

Energy upgrades and the implementation of electric transportation demand electrochemical storage systems with higher accessibility, energy density, and safety. While lithium ion batteries (LIBs) have been widely used, because lithium is a monovalent metal, the anode capacity is relatively limited.

Rechargeable batteries having a divalent metal anode (e.g., magnesium, calcium metal batteries, i.e., RMBs and RCBs, respectively, as well as zinc metal batteries) are promising alternatives to lithium-ion batteries (LIBs) due to their high crustal abundance and anode capacity. For example, the earth's crust has more than 1000 times higher amounts of Mg and Ca relative to lithium. Furthermore, Mg and Ca have a significantly larger anode capacity from two electron transfers (3832 mAh cm⁻³ for Mg and 2052.6 mAh cm⁻³ for Ca). Moreover, Mg and Ca metals have a low reduction potential (i.e., −2.38 V vs. standard hydrogen electrode [SHE] for Mg and −2.76 V vs. SHE for Ca) compared to lithium. More significantly, unlike LIBs, RMBs and RCBs have reduced safety concerns from the potentially dendrite-free plating of these divalent metal anodes.

Unfortunately, conventional RMBs and RCBs are plagued by sluggish kinetics and parasitic reactions.

Therefore, there is a need for (i) a method to increase charge transfer kinetics in rechargeable divalent metal batteries comprising a divalent metal anode and/or (ii) a method for reducing a charge transfer overpotential in rechargeable divalent metal batteries.

### BRIEF SUMMARY

Some aspects of the disclosure are based on a surprising and unexpected discovery by the present inventors that adding a multidentate compound to electrolytes of divalent metal batteries promotes and/or significantly increases the interfacial charge transfer kinetics. Furthermore, in some embodiments, multidentate compounds also suppress side reactions on both the cathode and the divalent metal anode. Without being bound by any theory, it is believed that suppression of side reactions is believed to be at least in part due to solvation sheath reorganization caused by the multidentate compound. In addition, multidentate compounds reduce or prevent side reactions, thereby significantly increasing stability and/or the number of reversible cycling.

One particular aspect of the disclosure provides a rechargeable divalent metal battery comprising a cathode; an anode comprising a divalent metal; and an electrolyte comprising a solvent, an electrolyte, and a multidentate compound. The terms “multidentate” and “polydentate” are used interchangeably herein and refer to a compound having multiple points, i.e., two or more, at which it can coordinate, attach, or form a bond to a central atom.

In general, any metal oxide cathodes having a suitable reduction potential disclosed herein can be used in the rechargeable divalent metal batteries of the disclosure. In some embodiments, said cathode comprises sulfur, a metal oxide, or a combination thereof. Exemplary cathodes of the disclosure include, but are not limited to, sulfur, Mo₆S₈, graphite-like MoS₂, TiS₂, FeS, vanadium sulfide (VS), magnesium-manganese oxides, Chevrel phase MxMo₃T₄ (M=metal, x an integer that depends on the oxidation state of M, T=S or Se), mesoporous Mg_{1.03}Mn_{0.97}SiO₄, manganese oxide, layered vanadium pentoxide, VO₂, LiMn₂O₄, magnesium-manganese oxide (MgₓMn_{y}O_{z}, where x, y, and z are ratios of Mg, Mn, and O, respectively), or a combination thereof. In one particular embodiment, the cathode material is Mg_{0.15}MnO₂. Still in other embodiments, the cathode comprises an organic molecule such as a pyrazine, an organic free-radical compound, 16 carbonyl compound, an imine compound, and an azo compound.

Still in other embodiments, said divalent metal comprises Mg, Ca, Zn, or a mixture thereof, or an alloy thereof. In general, any divalent metal, divalent metal alloy, or a mixture of divalent metal with another metal having a reduction potential of about at least −2.0 V (vs. standard hydrogen electrode), typically about at least −2.3 V, and often about at least −2.5 V can be used as an anode in the present disclosure. Accordingly, in some embodiments, the divalent metal anode has a reduction potential of about at least −2.3 V.

In general any aprotic organic solvent can be used in the electrolyte of the present disclosure. Exemplary solvents that can be used in electrolyte of the present disclosure include, but are not limited to, 1,2-dimethoxyethane, diethyl ether, tetrahydrofuran (THF), glyme (e.g., diethylene glycol dimethyl ether or G2, G3, G4, etc.), dimethylformamide (DMF), or a mixture thereof.

In further embodiments, said electrolyte comprises a salt having a weakly coordinating anion. The term “weakly coordinating anion” refers to an anion having its negative charge that is delocalized over two or more atoms rather than localized at a specific or on one particular atom. In general, any weakly coordinating anion can be used in rechargeable divalent metal batteries of the disclosure. Typically, weakly coordinating anions used in the present disclosure include, but are not limited to, anions used in ionic liquids such as tetrafluoroborate (BF₄), hexafluorophosphate (PF₆), trifluoromethanesulfonate (OTf), dicyanamide (N(CN)₂), hydrogen sulphate (HSO₄), ethyl sulphate (EtOSO₃), bis-trifluoromethanesulfonimide (NTf₂), and other phosphorous, sulfur, and nitrogen atom-based anions used in ionic liquids that are known to one of skilled in the art. In one particular embodiment, the weakly coordinating anion comprises bis(trifluoromethylsulfonyl)imide (TFSI), an alkyloxy borate, a fluorinated alkyloxy borate, an alkyloxy aluminate, and a fluorinated alkyloxy aluminate, or a mixture thereof.

Still in other embodiments, said multidentate compound comprises (i) a cyclic multidentate compound having at least one oxygen atom and at least one nitrogen ring atom or (ii) a linear or branched non-cyclic multidentate compound having at least one oxygen atom and at least one nitrogen atom.

In one particular embodiment, said cyclic multidentate compound comprises (b)-aza-(m)-crown-(n) compound, where “b” represents a number of nitrogen ring atoms, “m” represents the total number of ring atoms in the cyclic structure, and “n” represents the total number of heteroatoms. For example, diaza-18-crown-6 or “(2)-aza-(18)-crown-(6)” can include a compound of the formula:

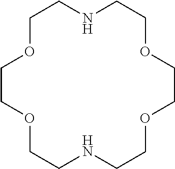 [SMILES: C1COCCOCCNCCOCCOCCN1]

(i.e., 1,4,10,13-tetraoxa-7,16-diazacyclooctadecane) or similar cyclic compounds having a total of 2 nitrogen atoms, a total of 6 heteroatoms, and a total of 18 atoms (including heteroatoms) in the ring structure. It should be appreciated that as long as two heteroatoms are not attached to each other, each heteroatom can be placed anywhere in the ring structure. Thus, compound (2)-aza-(18)-crown-(6) can also include:

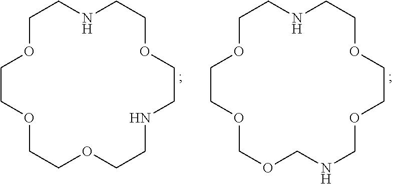

as well as other variations thereof. Referring again to “(b)-aza-(m)-crown-(n)” compound:
b is an integer from 1 to 4 and represents a number of nitrogen ring atoms, wherein each nitrogen ring atom is independently —NR^{a}, wherein R^{a} is H, alkyl, haloalkyl, or a nitrogen protecting group;
m is an integer from 6-100 and represents a total number of ring atoms in the ring structure; and
n is an integer from 2-32 and represents a total number of heteroatoms (O and N) in the ring structure,
   where each hetero atom in the ring structure is separated from one another by one, typically by at least two carbon atoms.

The term “alkyl” refers to a saturated linear monovalent hydrocarbon moiety of one to twelve, typically one to six, and often one to four carbon atoms or a saturated branched monovalent hydrocarbon moiety of three to twelve, typically three to six, and often three or four carbon atoms. Exemplary alkyl groups include, but are not limited to, methyl, ethyl, n-propyl, 2-propyl, tert-butyl, pentyl, and the like. The term “alkylene” means a linear saturated divalent hydrocarbon moiety of one to twelve, typically one to six, and often one to four carbon atoms or a branched saturated divalent hydrocarbon moiety of three to twelve, typically three to six, and often three or four carbon atoms, e.g., methylene, ethylene, propylene, 2-methylpropylene, pentylene, and the like.

Yet in another particular embodiment, said linear or branched non-cyclic multidentate compound is of the formula:

X¹—(R—X²)_{q}—R—X³

wherein
q is an integer from 0 to 10, typically 0 to 5, often from 0 to 3, and most often 0 to 2;
each R is independently a cycloalkylene, C₁-C₆ linear or branched alkylene, or C₁-C₆ linear or branched haloalkylene;
each of X¹, X², and X³ is independently —OR¹ or —NR²R³, provided at least one of X¹, X², and X³ is —OR¹ and at least one of X¹, X², and X³ is —NR²R³;
R¹ is alkyl or haloalkyl; and
each of R², and R³ is independently H, alkyl or haloalkyl.

The terms “haloalkyl” and “haloalkylene” refers to “alkyl” and “alkylene,” respectively, as defined herein where one or more hydrogen is replaced with a halide atom such as Cl, Br, I, or F. The term “cycloalkylene” refers to a saturated divalent cyclic hydrocarbon moiety of three to seven ring carbons. Exemplary cycloalkylenes include, for example, cyclopropylene, cyclohexylene, cyclopentylene, and the like.

In one particular embodiment, q is 1.

Still in other embodiments, R is C₁₋₆ linear or branched alkylene or C₁₋₆ linear or branched haloalkylene; typically C₁₋₄ linear or branched alkylene or C₁₋₄ linear or branched haloalkylene; and often C₁₋₃ linear or branched alkylene or C₁₋₃ linear or branched haloalkylene. In one particular embodiment, R is C₂ or C₃ linear or C₃ branched alkylene, or C₂ or C₃ linear or branched C₃ haloalkylene.

Yet in other embodiments, the ratio of said solvent to said multidentate compound ranges from about 1 to about 1 by weight, typically from about 2 to about 1, often 3 to 1, more often 4 to 1, and most often 5 to 1.

Another aspect of the disclosure provides a rechargeable divalent metal battery comprising a cathode, a divalent metal anode, and an electrolyte, wherein said rechargeable divalent metal battery has an energy density of at least about 400 Wh kg⁻¹ and an average coulombic efficiency of at least 80%, typically at least 85%, often at least 90%, and more often at least 95%. Typically, in most conventional batteries during the first few, i.e., first 10, typically first 20, and often first 25 recharging cycles, the coulombic efficiency (CE) is low compared to the theoretically calculated CE value. Only after a few discharge/recharge cycles, the CE value stabilizes. Thus, the term “average coulombic efficiency” refers to an average coulombic efficiency measured at 10th cycle, typically at 20th cycle, often at 25th cycle, more often at 50th cycle, and most often at 100^{th} cycle under conditions disclosed herein.

In some embodiments, said electrolyte comprises a solvent, an electrolyte salt, and a multidentate compound, such as those disclosed herein. As used herein, when referring to a variable the terms “those defined above,” “those defined herein,” and “those disclosed herein” are used interchangeably herein and incorporate by reference the broad definition of the variable as well as any narrower definition(s), if any.

Still in other embodiments, said multidentate compound comprises (i) a cyclic multidentate compound having at least one oxygen and at least one nitrogen ring atom or (ii) a linear or branched non-cyclic multidentate compound having at least one oxygen and at least one nitrogen atoms. Suitable multidentate compounds are those disclosed herein.

Yet in other embodiments, said divalent metal anode comprises a divalent metal those described herein including, but not limited to, Mg, Ca, Zn, or a mixture thereof, or an alloy thereof. Exemplary alloys of Mg, Ca, and Zn that are suitable include, but are not limited to, alloys of tin (Sn), bismuth, silicon, and copper. Alternatively, the divalent metal anode has a reduction potential of about −2.0 V or less, typically about −2.3 V or less, and often about −2.5 V or less.

In further embodiments, said cathode comprises a metal oxide. Exemplary metal oxides that can be used in the present disclosure include, but are not limited to, manganese metal oxide, layered vanadium pentoxide, or a combination thereof.

In other embodiments, said rechargeable divalent metal battery is a solid-state battery.

Still another aspect of the disclosure provides a method for reducing a charge transfer overpotential for a divalent metal anode in a rechargeable divalent metal battery. The method comprises adding a multidentate compound to an electrolyte of said rechargeable divalent metal battery. The term “charge transfer overpotential” refers to the difference between the electrode potential E and the formal potential E^{0′}, e.g., the potential difference between a half-reaction's thermodynamically determined reduction potential and the potential at which the redox event is experimentally observed. Accordingly, by adding a multidentate compound to the electrolyte, methods of the disclosure reduce the charge transfer overpotential by about 20% or more, typically about 30% or more, often about 40% or more, and most often about 50% or more relative to the same electrolyte in the absence of the multidentate. Alternatively, the rechargeable divalent metal battery examples of the present disclosure have charge transfer overpotential of about 0.5 V or less, typically about 0.2 V or less, and often about 0.1 V or less at current density of 1.5 mA/cm².

In some embodiments, said divalent metal anode is those disclosed herein such as Mg, Ca, Zn, or a mixture thereof. In other embodiments, the divalent metal anode has a reduction potential of about −2.0 V or less, typically about −2.3 V or less, and often about −2.5 V or less.

Yet in other embodiments, said multidentate compound comprises those described herein. In one particular embodiment, multidentate compound is a cyclic multidentate compound of the formula: (b)-aza-(m)-crown-(n), where
b is an integer from 1 to 4 and represents a number of nitrogen ring atoms, wherein each nitrogen ring atom is independently —NR^{a}, wherein R^{a} is H, alkyl, haloalkyl, or a nitrogen protecting group;
m is an integer from 6-100 and represents a total number of ring atoms in the ring structure; and
n is an integer from 2-32 and represents a total number of heteroatoms (O and N) in the ring structure,
   and wherein
each hetero atom in the ring structure is separated by another heteroatom by at least two carbon atom chains.

In further embodiments, said multidentate compound is a linear or branched non-cyclic multidentate compound of the formula:

X¹—(R—X²)_{q}—R—X³

wherein
q is an integer from 0 to 10;
each R is independently a cycloalkylene, C₁-C₆ linear or branched alkylene, or C₁-C₆ linear or branched haloalkylene;
each of X¹, X², and X³ is independently —OR¹ or —NR²R³, provided at least one of X¹, X², and X³ is —OR¹ and at least one of X¹, X², and X³ is —NR²R³;
R¹ is alkyl or haloalkyl; and
each of R², and R³ is independently H, alkyl or haloalkyl.

In one particular embodiment, q is 1.

Still in other embodiments, R is C₁₋₆ linear or branched alkylene or C₁₋₆ linear or branched haloalkylene. In further embodiments, R is C₂ or C₃ linear or C₃ branched alkylene, or C₂ or C₃ linear or C₃ branched haloalkylene.

Yet another aspect of the present disclosure provides a method for increasing a charge transfer kinetics in a rechargeable divalent metal battery comprising a divalent metal anode, said method comprising adding a multidentate compound to an electrolyte of said rechargeable divalent metal battery. As used herein, the term “charge transfer kinetic” refers to interfacial charge transfer rate, e.g., charge transfer rate between liquid-solid interface or between anode and electrolyte or between cathode and electrolyte. Accordingly, by adding a multidentate compound to the electrolyte, methods of the disclosure increase the charge transfer kinetics between the anode and the electrolyte by at least about 5%, typically by at least about 10%, often by at least about 15%, and most often by at least about 20% relative to the same anode and electrolyte in the absence of the multidentate. Alternatively, the rechargeable divalent metal battery of the invention has the overpotential of charge transfer reactions between the anode and the electrolyte of about 0.5 V or less at current density of 1.5 mA/cm², typically about 0.2 V or less at current density of 1.5 mA/cm², and often about 0.1 V or less at current density of 1.5 mA/cm².

In some embodiments, said divalent metal anode comprises a divalent metal selected from the group consisting of Mg, Ca, Zn, or a mixture thereof. Yet in other embodiments, said multidentate compound comprises (i) a cyclic multidentate compound having at least one oxygen and at least one nitrogen ring atoms or (ii) a linear or branched non-cyclic multidentate compound having at least one oxygen and at least one nitrogen atoms. In one particular embodiment, said cyclic multidentate compound comprises (b)-aza-(m)-crown-(n) compound, where
b is an integer from 1 to 4 and represents a number of nitrogen ring atoms, wherein each nitrogen ring atom is independently —NR^{a}, wherein R^{a} is H, alkyl, haloalkyl, or a nitrogen protecting group;
m is an integer from 6-100 and represents a total number of ring atoms in the ring structure; and
n is an integer from 2-32 and represents a total number of heteroatoms (O and N) in the ring structure,
   and wherein
each hetero atom in the ring structure is separated by another heteroatom by at least two carbon atom chains.

Yet in another particular embodiment, said linear or branched non-cyclic multidentate compound is of the formula: X¹—(R—X²)_{q}—R—X³, where
q is an integer from 0 to 10;
each R is independently a cycloalkylene, C₁-C₆ linear or branched alkylene, or C₁-C₆ linear or branched haloalkylene;
each of X¹, X², and X³ is independently —OR¹ or —NR²R³, provided at least one of X¹, X², and X³ is —OR¹ and at least one of X¹, X², and X³ is —NR²R³;
R¹ is alkyl or haloalkyl; and
each of R², and R³ is independently H, alkyl or haloalkyl.

In one particular embodiment, q is 1. Still in another embodiment, R is C₁₋₆ linear or branched alkylene or C₁₋₆ linear or branched haloalkylene. Yet in another embodiment, R is C₂ or C₃ linear or C₃ branched alkylene, or C₂ or C₃ linear or C₃ branched haloalkylene.

### BRIEF DESCRIPTION OF THE DRAWINGS

FIG. 1A is a graph showing comparison of cell-specific energy (Wh/kg) between Li-ion batteries based on graphite-LiCoO₂ (LCO) or graphite-LiNiₓMn_{y}Co_{z}O₂ (NMC) chemistry and RMBs paired with different cathodes. The black dashes represent the voltage required for a 200 Ah/g (or 600 Ah/L) cathode to have energy density comparable to Li-ion batteries. The calculations for specific energy and energy density are shown below, the parameters used are tabulated in Table 1.

FIG. 1B is a graph showing comparisons of energy density (Wh/L) between Li-ion batteries based on graphite-LiCoO₂ (LCO) or graphite-LiNiₓMn_{y}Co_{z}O₂ (NMC) chemistry and RMBs paired with different cathodes. The black dashes represent the voltage required for a 200 Ah/g (or 600 Ah/L) cathode to have energy density comparable to Li-ion batteries. The calculations for specific energy and energy density are shown below, the parameters used are tabulated in Table 1.

FIG. 1C is a graph showing comparison of cell-specific energy (Wh/kg) between Li-ion batteries based on graphite-LiCoO₂ (LCO) or graphite-LiNiₓMn_{y}Co₇O₂ (NMC) chemistry and RCBs paired with different cathodes. The black dashes represent the voltage required for a 200 Ah/g (or 600 Ah/L) cathode to have energy density comparable to Li-ion batteries. The calculations for specific energy and energy density are shown below, the parameters used are tabulated in Table 1.

FIG. 1D is a graph showing comparisons of energy density (Wh/L) between Li-ion batteries based on graphite-LiCoO₂ (LCO) or graphite-LiNiₓMn_{y}Co_{z}O₂ (NMC) chemistry and RCBs paired with different cathodes. The black dashes represent the voltage required for a 200 Ah/g (or 600 Ah/L) cathode to have energy density comparable to Li-ion batteries. The calculations for specific energy and energy density are shown below, the parameters used are tabulated in Table 1.

FIGS. 2A-2E show graphs of overpotentials of Mg anode tested in Mg∥Mg coin cell in (A) blank, i.e., no multidentate compound present, (B) E1, (C) E2, (D) E3 and (E) E4 at 0.1, 0.2, 0.5, 0.75, 1, 1.5 and 3 mA cm⁻².

FIG. 3A shows the overpotentials at the 10^{th} cycle for deposition and stripping in Mg∥Mg cells at 1.5 mA cm⁻² for 1.5 mAh/cm² in blank and Ex.

FIG. 3B shows the overpotentials at the 10^{th} cycle for deposition and stripping in Mg∥Mg cells at 0.1 mA cm⁻² for 0.1 mAh/cm² (C) in blank and Ex.

FIG. 4 Shows CEs for Mg deposition and stripping in electrolytes comprising various multidentate compound Ex in Mg∥SS cells cycled at 0.1 mA cm⁻².

FIG. 5 shows the results of long-term cycling of the Mg∥SS cell in E4 at current density of 0.1 mA cm⁻².

FIG. 6 shows CE during cycling of Mg in Mg∥SS cell in E4 at current density of 1.5 mA cm⁻² for areal capacity of 1.5 mAh cm⁻².

FIG. 7 shows the correlation between overpotential (η) and reorganization energy (λ) for different reaction modes of the Mg anodes. The dashed line represents when the λ for electron transfer is equal to η.

FIG. 8 is an electrochemical impedance spectra for Mg_{0.15}MnO₂ at a 0% state of discharge in the three-electrode cell after 25 cycles in blank and E4, with Mg counter electrode and magnesiated Mo₆S₈ reference electrode. EIS was measured between 10⁶ Hz to 0.1 Hz, with AC oscillation of 10 mV amplitude.

FIG. 9A shows the charge/discharge curve of the Mg_{0.15}MnO₂∥Mg cell in E4 and blank at 0.5 C (1C=200 mA g⁻¹).

FIG. 9B shows the capacity and CE of Mg_{0.15}MnO₂∥Mg cycled in E4 at 0.5C.

FIG. 10A shows the charge and discharge curves of Ca∥Mg_{0.15}MnO₂ cell in the 0.5M Ca[B(hfip)₄]₂ in DME-M4B electrolyte at 0.5 C (1C=200 mA/g).

FIG. 10B shows the capacity retention and coulombic efficiency of the Ca∥Mg_{0.15}MnO₂ cell battery of FIG. 10A.

### DETAILED DESCRIPTION

The present disclosure provides various examples and aspects of a versatile electrolyte design for divalent metal batteries. In some examples, reorganization of a solvation sheath reduces the charge transfer overpotential for divalent metal anodes (e.g., Mg, Ca, or Zn anodes) and high-voltage metal-oxide cathodes.

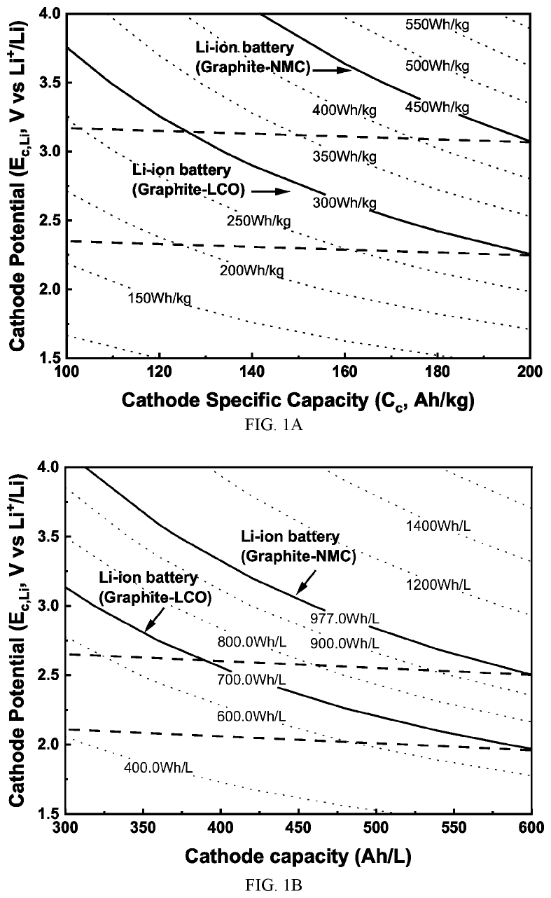

In some embodiments, the metal anode of the rechargeable divalent metal batteries with energy density comparable or higher than the commercial lithium-ion batteries (LIBs) is paired with a cathode with potential of at least about 3.0 V, typically at least about 3.2 V, often at least about 3.5 V vs. Li⁺/Li. See Table 1 and FIG. 1. The calculations for specific energy and energy density are shown below, the parameters used are tabulated in Table 1.

$$Specific Energy ( Wh {kg}^{- 1} ) = Cell Voltage \times \frac{1}{( 1 / cathode specific capacity + 1 / anode specific capacity )} \\ or$$

$$Energy density ( Wh {L}^{- 1} ) = Cell Voltage \times \frac{1}{( 1 / cathode capacity + 1 / anode capacity )}$$

TABLE 1
Parameters for Li-ion, magnesium metal and calcium metal batteries used to
calculate the energy density and specific energy density shown in FIG. 1.

| | Li-ion batteries | | |
|---|---|---|---|
| | (Graphite-LCO or | Magnesium metal | Calcium metal |
| | Graphite-NMC) | batteries | batteries |
| Cathode potential (V | 3.6 (LCO) | E_{c, Li} | E_{c, Li} |
| vs Li⁺/Li) | 3.9 (NMC) | | |
| Cell Voltage (V) | 3.5 (LCO) | E_{c, Li} −0.62 | E_{c, Li} −0.24 |
| | 3.8 (NMC) | | |
| Cathode Specific | 120 (LCO) | C_{c} | C_{c} |
| Capacity (Ah/kg) | 200 (NMC) | | |
| Cathode Capacity | 360 = 120 Ah/kg * | C_{c}* 3 g/cm³ | C_{c}* 3 g/cm³ |
| (Ah/L) | 3 g/cm^{3, A} (LCO) | | |
| | 600 = 200 Ah/kg * | | |
| | 3 g/cm^{3, A} (NMC) | | |
| Anode Specific | 300 | 2205 | 1324 |
| Capacity (Ah/kg) | | | |
| Anode Capacity | 450 = 300 mAh/g * | 3832 | 2053 |
| (Ah/L) | 1.5 g/mL^{A} | | |

^{A}The density of cathode and anode in Li-ion batteries are based on LiCoO₂ cathode and graphite anode.

In one particular embodiment, a cathode having potential of about 2.5 V or greater is used in the rechargeable divalent metal batteries of the disclosure. Exemplary cathodes suitable for such pairing include metal oxide cathodes such as those disclosed herein, e.g., layered vanadium pentoxide, NiO₂, or CoO₂. However, it should be appreciated that cathodes of the disclosure are not limited to any particular metal oxides, in general any cathode material having a potential disclosed herein can be used as a cathode in rechargeable divalent metal batteries of the disclosure.

In LIBs, a Li⁺ desolvates and transports through the electron insulating solid-electrolyte interphase (SEI) to the electrode materials. Desolvation and transport of the divalent ions through SEI and active materials, however, are more challenging due to stronger electrostatic interactions, leading to large overpotentials, further electrolyte decomposition, and irreversible phase transformations or failure to intercalate in cathode materials. Reductive and chloride-containing non-aqueous electrolytes avoid SEI formation on Mg anodes but suffer from low anodic stability and incompatibility with current collectors and battery casings. Aqueous electrolytes assist Mg²⁺ intercalation in high-voltage cathodes, but do not support reversible metal anodes. To bridge the incompatibility among electrolytes to the cathode, anode and current collectors, some have used electrolytes consisting of noncorrosive electron delocalizing anions, such as magnesium bis(trifluoromethane-sulfonimide) (Mg(TFSI)₂), boron clusters, alkoxyborate/alkoxyaluminates and an artificial SEI on a Mg anode. However, Mg and Ca anodes still suffer from insufficient coulombic efficiency (CE) while large hysteresis is observed on a cathode side.

The present disclosure overcomes one or more of these disadvantages by utilizing an electrolyte that comprises a multidentate compound. Surprisingly and unexpectedly, the present inventors have discovered that adding a multidentate compound to an electrolyte significantly promotes the interfacial charge transfer kinetics and suppresses side reactions on both the cathode and metal anode through solvation sheath reorganization, thus enabling stable and highly reversible cycling of the rechargeable divalent metal batteries. In some particular embodiments, the RMB full cells of the disclosure have an energy density of at least about 350 Wh kg⁻¹, typically at least about 375 Wh kg⁻¹, often at least about 400 Wh kg⁻¹, and most often at least about 412 Wh kg⁻¹. Yet in other embodiments, RCB full cells of the disclosure have an energy density of at least about 350 Wh kg⁻¹, typically at least about 375 Wh kg⁻¹, often at least about 400 Wh kg⁻¹, more often at least about 425 Wh kg⁻¹, still more often at least about 450 Wh kg⁻¹, and most often at least about 471 Wh kg⁻¹. In other embodiments, RMBs and RCBs of the disclosure have significantly increased charge transfer kinetics compared to the same RMBs and RCBs in the absence of a multidentate compound in the electrolyte.

Some aspects of the disclosure provide a method for effecting the reorganization of a solvation sheath to reduce the charge transfer overpotential for Mg or Ca anodes. Such reorganization of a solvation sheath reduction is particularly effective when a divalent metal anode is used with a high-voltage metal-oxide cathode, and an electrolyte comprising a multidentate compound. As an example, experiments have shown that the multidentate methoxyethyl-amines chelants (—(CH₂OCH₂CH₂N)ₙ—) in the first solvation sheath of Mg²⁺ and Ca²⁺ enabled both highly reversible Mg and Ca anodes, as well as fast (de) intercalation of Mg²⁺ and Ca²⁺ into high-voltage layered oxide cathodes. These multidentate compounds (i.e., chelants) provide at least about 6 to about 41 times higher affinity for Mg²⁺ than traditional ether solvents. Yet the chelant-rich solvation sheaths bypass the energetically unfavorable desolvation process through reorganization, thus reducing the overpotential and eliminating the concomitant parasitic reactions for both the anode and cathode. The reorganization energy of these electrolytes can be tuned or modified, for example, by changing the dielectric constants and sizes of the chelants.

### Mg Plating/Stripping in Chelating Electrolytes

A 0.5 M Mg(TFSI)₂ in 1,2-dimethoxyethane (DME) electrolyte was adopted as baseline (blank) due to its chemical stability and commercial accessibility. The electrolytes used are 0.5 M Mg(TFSI)₂ in DME-Mx (x=1, 2, 3, or 4), in which M1 is a hexadentate chelant (1,4,10,13-tetraoxa-7,16-diazacyclooctadecane), M2 is a tridentate chelant (bis(2-methoxyethyl)amine), and M3 and M4 are bidentate chelants (2-methoxyethan-1-amine and 2-methoxy-1-propan-2-amine, respectively) for Mg²⁺. The quantities of Mx were varied to keep the molar ratios between donor atoms (i.e., heteroatoms, such as N and O) in Mx to Mg²⁺ at 8:1. These electrolytes comprising these chelants or multidentate compounds are referred to as Ex (x=1, 2, 3, or 4), respectively.

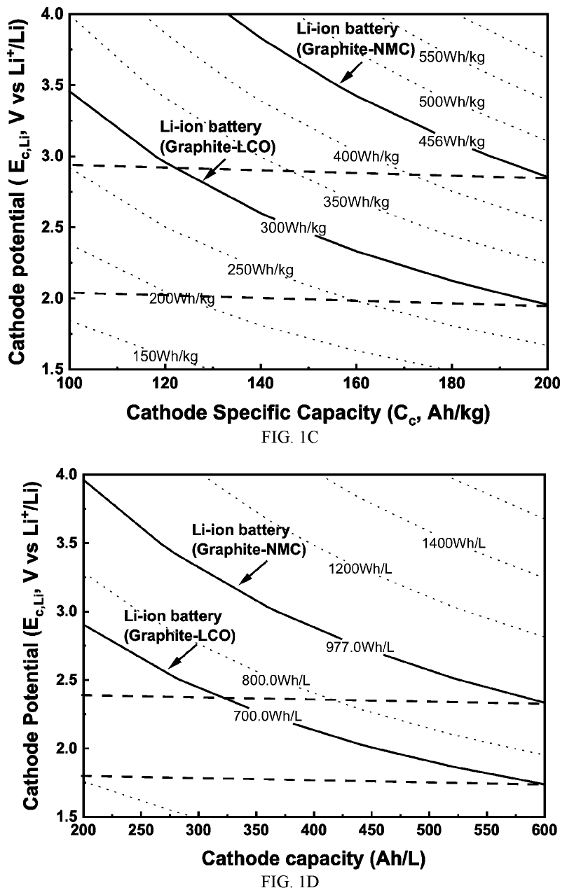

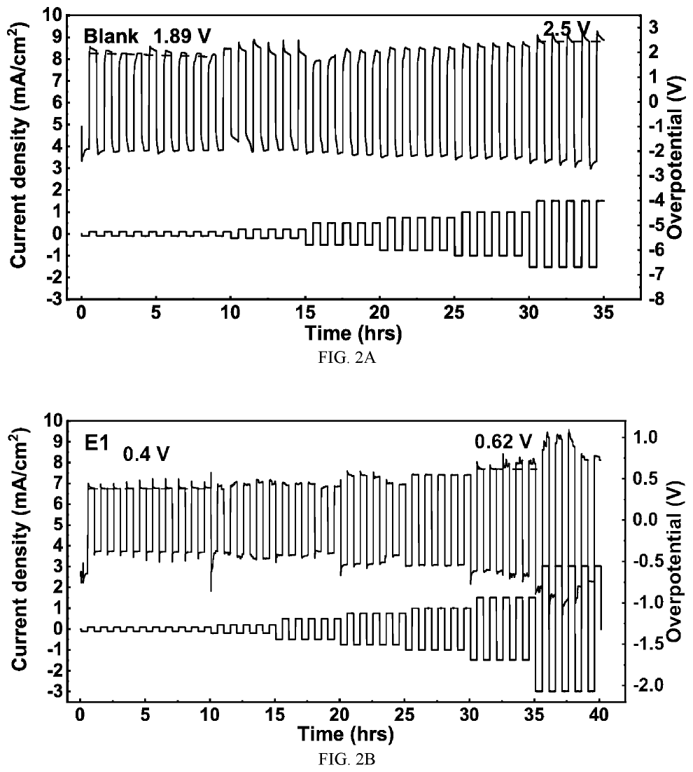

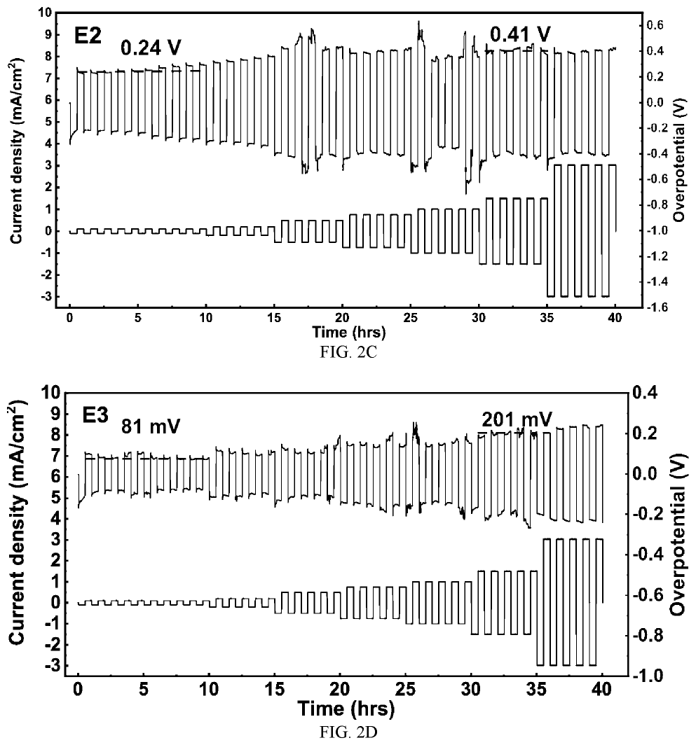

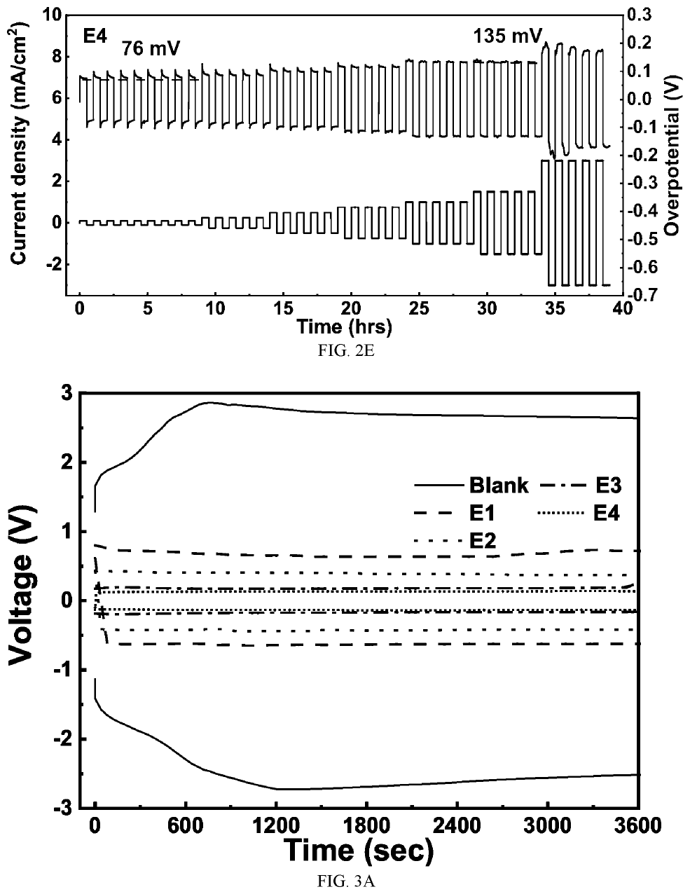

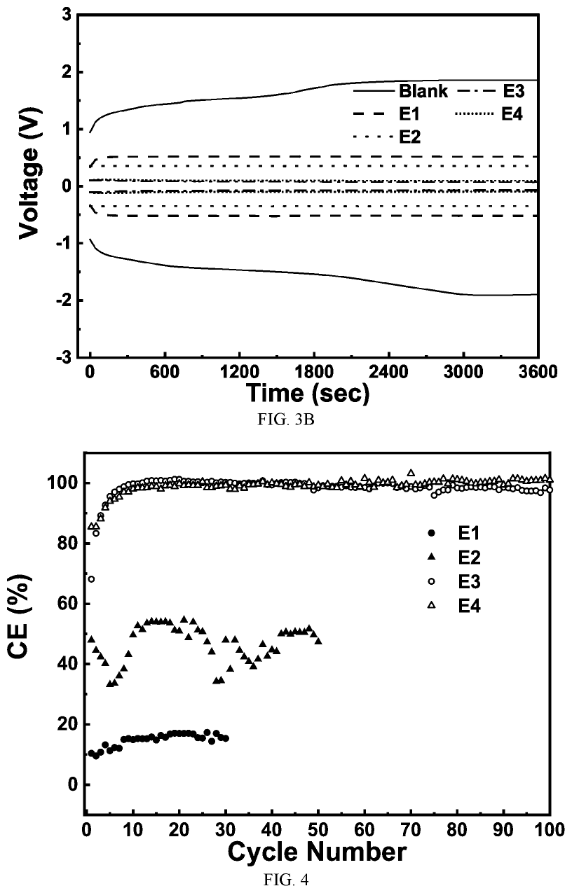

Mg plating/stripping overpotentials were evaluated in Mg∥Mg symmetric cells at a variety of currents. FIGS. 2A-2E. Consistent with previous studies, the overpotentials are around 2.0 V in the blank (i.e., without any multidentate compound), but are significantly reduced in Ex, dropping to below 0.1 V in E4. FIGS. 3A and 3B. Accordingly, in some embodiments, RMBs of the disclosure have the overpotential of about 1.5 V or less, typically about 1.0 V or less, often about 0.5 V or less, more often about 0.25 V or less, still more often about 0.20 V or less, and most often about 0.1 V or less in conditions used to obtain data shown in FIGS. 3A and 3B. Since the ionic conductivities of Ex (4.0-5.3 mS cm⁻¹) are smaller than that of blank (6.5 mS cm⁻¹), the reduced overpotentials in Ex are not attributed to bulk ion transport but rather to the interfacial charge transfer kinetics. As overpotentials reduce, the cycling CEs (cCEs, the average CE after 10 cycles) in Mg∥stainless steel (SS) cells increase from 0% in blank (due to no Mg stripping at the cutoff potential of 1.0 V vs. Mg²⁺/Mg) to over 99.5% in E4 (FIG. 4) with stable overpotentials (FIGS. 5 and 6) and substantially (i.e., at least 90%, typically at least 95%, and often at least 99%) dendrite-free Mg deposit.

The surfaces of the cycled Mg were characterized by high-resolution X-ray photoelectron spectroscopy (HRXPS). The decomposition products from DME and TFSI⁻ are summarized in Table 2.

TABLE 2
Peak assignments for X-ray Photoelectron Spectroscopy (XPS).

| Material | Source | Species | Binding Energy (eV) |
|---|---|---|---|
| Mg | Solvent | Polymeric and organic | 285-286 (—C—H, —C—O) (62)* |
| | Decomposition | residues | 287 (Polyester or —C═O) (62)* |
| | | | 532-533 (Polyether or —C—O—C)** |
| | | | 533.5-534 (Polyester or O═C—O—)** |
| | | MgCO₃ | 290.3* |
| | Salt | MgO/Mg(OH)ₓ | 530.8** |
| | Decomposition | Crystalline Mg(OH)₂ | 52 (crystalline Mg(OH)₂)*** |
| | | | 49.8 (MgOH)ₓ(68, 69), 51 (MgO)*** |
| | | | 532** |
| | | —SOₓ^{A}, —Sₓ^{A} | 163-169**** |
| | | | 161.5-163**** |
| | | —CF₂, —CF | 686.5-687.5# |
| | | —CF₂—CF₂— | 689.4-690# |
| | | MgF₂ | 685-686# |
| | | —N—S | 401## |
| | Salt Adsorption | O═S═O^{A} | 533** |
| | | | 169.4**** |
| | | —CF₃ | 293* |
| | | | 688.2-688.6# |
| | | S—N—S | 399.6-400## |
| | Pristine Mg | Mg | 49.4*** |
| | | MgO | See above |
| | | MgCO₃ | See above |

| | | | Binding | Full Width at Half |
|---|---|---|---|---|
| | | | Energy | Maximum |
| | | | (eV) | (FWHM) (eV) |
| MgₓMnO₂ | Redox of Mn | Mn(II), MnO ^{B} | 640.3 ### | 1.70 ### |
| | | | 641.5 | 1.20 |
| | | Mn(III), Mn₂O₃ ^{B} | 640.8 ### | 1.25 ### |
| | | | 641.9 | 1.25 |
| | | | 643.1 | 1.25 |
| | | Mn(IV), Birnessite ^{B} | 642.5 ### | 1.25 ### |
| | | | 643.5 | 1.3 |
| | | | 644.3 | 1.3 |

*= C 1s;
**= O 1s;
#= F 1s;
****= S 2p 3/2;
***= Mg 2p;
##= N 1s;
### = Mn 2p 3/2.
^{A}Each S 2p 3/2 peak assignment generates a 2p 1/2 spin-orbit split couple in the spectrum with +1.16 eV separation and 0.6667 area ratio.
^{B} Peak assignment for Mn 2p 3/2 is based on both binding energies and FWHM. The peaks marked with stars are unique for the corresponding oxidation state. The inseparable peak group between 640.8 and 641.9 eV is assigned as Mn²⁺/Mn³⁺. The inseparable peak groups between 642.5 and 642.7 eV, 643.5 and 643.7 eV are assigned as Mn³⁺/Mn⁴⁺.

No signs of Mx decomposition were observed in the N is spectrum (data not shown). The species from electrolyte decomposition, in particular —C═O (C is and O 1s), crystalline Mg(OH)₂ (Mg 2p), —CFₓ (F 1s), —SOₓ (x<2, S 2p) and MgSₓ (S 2p) are abundant on Mg cycled in blank, but diminish on Mg cycled in Ex (data not shown). The decomposition layer was also much thicker in blank as evidenced by the almost unchanged F and O accumulations after 12-minute Ar⁺ sputtering (data not shown). In contrast, the F and O accumulations on Mg cycled in E3 and E4 were negligible and can be removed with a much shorter sputtering time. The relative concentrations of these decomposed species showed significant dependence on the overpotentials. Thus, by reducing the overpotentials for Mg plating/stripping, electrolyte decomposition was suppressed or avoided and cCE was enhanced in Ex.

### Solvation Sheath Structure

Without effective SEI, the solvation environment of Mg²⁺ serves as the key to understanding how Mx improves charge transfer kinetics of the Mg anode, which was probed using ¹³C nuclear magnetic resonance (NMR). Chemical shifts of methylene carbons in DME (δ_{DME}) and Mx (δ_{Mx}) shift up-field in the presence of Mg(TFSI)₂ (data not shown). These changes (Δδ_{DME} and Δδ_{Mx}) reflect the stoichiometric average between bound and free states. Thus, a smaller Δδ_{DME} in Ex indicates DME is partially freed from the solvation sheath. Meanwhile, the significant association of Mx in the solvation sheath is evidenced by the >10 times higher values of Δδ_{Mx} than Δδ_{DME}. Using Δδ_{Mx} and Δδ_{DME}, the relative affinities of Mx-Mg²⁺ over DME-Mg²⁺ interactions were quantified (Table 3), in which M1, M2, M3 and M4 show 41-, 12-, 10- and 6-times higher affinities with Mg²⁺, respectively, than DME. Separate analysis of N and O stoichiometry through Δδ_{Mx-N} and Δδ_{Mx-o} (Δδ_{Mx} of carbon next to N and O, respectively) show that the association of N in the solvation sheath significantly reduces from E1 to E4, but the association of O from Mx is in general greater than O from DME in the solvation sheath. Interestingly, bond lengths calculated from molecular dynamic simulations show that Mg²⁺—N bonds in Mx are 0.2 to 0.3 Å shorter than those in monodentate amines, while the Mg²⁺—O bond lengths remain the same for DME and Mx. Therefore, without being bound by any theory, it is believed that the higher affinity between Mx and Mg²⁺ is likely to be initiated by the strengthened Mg²⁺—N bonds that in turn promote the Mg²⁺—O association.

TABLE 3
Relative affinity of Mg²⁺-Mx interactions over
Mg²⁺-DME determined through ¹³C NMR.

| Electrolyte | γ_{DME} | γ_{Mx} | Relative affinity |
|---|---|---|---|
| Blank | 0.0519 | N/A | N/A |
| E1 | 0.0203 | 0.462 | 41.3 |
| E2 | 0.0425 | 0.360 | 12.7 |
| E3 | 0.0438 | 0.308 | 9.75 |
| E4 | 0.0491 | 0.236 | 5.98 |

y_{DME} and y_{Mx} represent the molar percentage of DME or Mx at the bound state, respectively.

Formation of contact ion pairs (CIPs) between TFSI⁻ and Mg²⁺ was also characterized with Raman spectroscopy as CIPs potentially facilitate the decomposition of TFSI⁻ and reduce anode reversibility. The S—N stretching vibration in TFSI⁻ that is sensitive to ionic interactions was deconvoluted to identify the solvent-separated ion pairs (SSIPs) and CIPs. CIP percentages obtained by normalizing CIPs to total peak areas show that only 15-20% of the TFSI⁻ are in contact with the cations in both blank and Ex. Thus, the major role of Mx is to displace DME instead of TFSI⁻ from the solvation sheath. Due to the high affinity between Mx and Mg²⁺, the solvation sheaths containing Mx are more stable than the Mg²⁺(DME)₃ solvates in blank by 0.3 eV to 1 eV (30 kJ mol⁻¹ to 100 kJ mol⁻¹) as from density-functional theory (DFT) calculations. Of the four multidentate compounds tested, M1 has the strongest affinity to Mg²⁺ followed by M2 and M4≈M3 in agreement with NMR results and molecular dynamic simulations.

### Solvation Sheath Reorganization Mediated Charge Transfer on Mg Anode

To understand why solvates in Ex with much higher binding energies than those in blank can support Mg plating/stripping with much smaller overpotentials, the electron transfer from an electrode to solvated Mg²⁺ was analyzed. It is approximated as nonadiabatic, involving ionic intermediates with the reorganized solvation sheath according to Marcus theory. For electrode-bound electrochemical reactions, the overpotentials (η) represent the potential required to vary the Fermi level (E_{F}) of the electrode for each electron transferred, the reorganization energy (λ) represents the energy to reorganize the solvation sheath to accept the electron. The values of λ were obtained by fitting the Tafel plots for Mg anode with Marcus-Hush-Chidsey kinetics (equation S2).

$$i = A {\int }_{- ∞}^{+ ∞} exp \{ - \frac{{( x - λ \pm \tilde{η} )}^{2}}{4 λ} \} \frac{d x}{1 + exp \{ x \}} \qquad ( S2 )$$

where A is the pre-exponential factor,

$$\tilde{η} = η \frac{e}{{k}_{B} T}$$

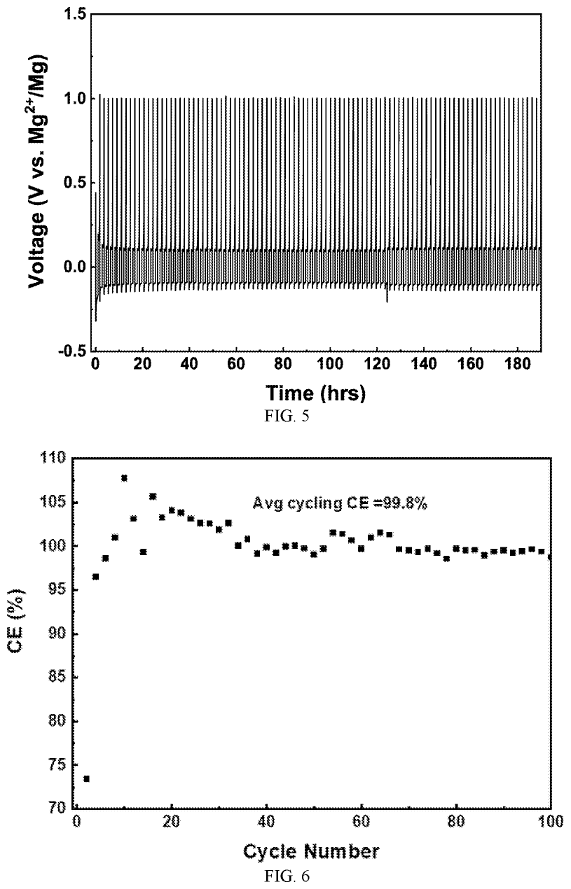

is the dimensionless overpotential, in which k_{B} is the Boltzmann's constant, T is the absolute temperature=298.15 K and e is the elementary charge; i is the current density. The reorganization energy fitted is divided by k_{B}T to give the non-scaled reorganization energy (eV) in FIG. 7.

To minimize interference from the morphological difference of Mg deposits and the electrolyte decomposition during Mg plating, only the stripping overpotentials of the freshly polished Mg were collected for fitting. The fitted λ showed distinct correlations with the η in three regions, marked as I, II and III (FIG. 7). Reactions in E3 and E4 fall in region I, in which λ for Mg²⁺ redox is significantly smaller than the onset of decomposition potential (E_{D}) resulting in little electrolyte decomposition, and the η agrees well with the λ, reflecting that the electrons are transferred reversibly to Mg²⁺; while reactions in E2 and E1 fall in region II, in which λ overlaps with E_{D}, and the η slightly deviates from the postulated λ for Mg²⁺ redox, reflecting that some side reactions take place; reactions in blank fall in region III, in which the λ is larger than E_{D}, and the η significantly deviated from the postulated λ for Mg²⁺ redox since the major reaction is now dominated by electrolyte decomposition (FIG. 7).

The solvation sheath reorganization energy (λ) can be expressed as a dielectric continuum formulation (equation (1)):

$$λ = \frac{{e}^{2}}{4 π {ε}_{0}} ( \frac{1}{{a}_{0}} - \frac{1}{R} ) ( \frac{1}{{ε}_{o p}} - \frac{1}{{ε}_{s}} ) \qquad ( 1 )$$

where, ε₀ is the vacuum permittivity, e is electron charge, a₀ is the solvated radius of the cations, R is the distance between the solvated ions and electrode surface, εₒₚ is the optical dielectric constant and εₛ is the static dielectric constant), in which the λ is proportional to the distance part

$$( \frac{1}{{a}_{0}} - \frac{1}{R} )$$

and dielectric part

$$( \frac{1}{{ε}_{o p}} - \frac{1}{{ε}_{s}} ) .$$

the distance part gradually reduces from blank to E4 due to a less compact solvation sheath (smaller 1/a₀ except for M3, Table 4).

TABLE 4
The solvated radii (a₀) and reciprocal of solvated radii
(1/a₀). The a₀ of different Mg²⁺ species in Eₓ are defined
as the summation of the distance from the farthest atom to the
geometry center of the B3LYP/6-311G(d,p) optimized solvation structures.

| Electrolyte | Solvated ion clusters | a₀ (nm) | 1/a₀ (nm⁻¹) |
|---|---|---|---|
| Blank | Mg²⁺(DME)₃ | 4.289 | 0.233 |
| E1 | Mg²⁺(M1) | 4.158 | 0.186 |
| | Mg²⁺(M1)(DME) | 5.357 | 0.167 |
| | Mg²⁺(M1)(DME)₂ | 6.041 | 0.165 |
| E2 | Mg²⁺(M2)₃ | 7.041 | 0.142 |
| | Mg²⁺ (M2)₂ | 4.139 | 0.242 |
| | Mg²⁺(M2)(DME) | 4.187 | 0.239 |
| | Mg²⁺(M2)(DME)2 | 5.687 | 0.175 |
| E3 | Mg²⁺ (M3)₃ | 4.288 | 0.233 |
| | Mg²⁺(M3)₂(DME) | 4.314 | 0.232 |
| | Mg²⁺(M3)(DME)₂ | 4.156 | 0.240 |
| E4 | Mg²⁺(M4)₃ | 5.320 | 0.188 |
| | Mg²⁺(M4)₂(DME) | 5.123 | 0.195 |
| | Mg²⁺(M4)(DME)₂ | 4.987 | 0.200 |

In addition, formation of decomposition products during cycling increases the distance between solvated ions and electrode R. This leads to λ increase. The dielectric part also reduces progressively from blank to E4. Considering

$$\frac{1}{{ε}_{o p}} and \frac{1}{{ε}_{s}}$$

represent fast and slow solvent motions upon electron transfer, respectively, the smaller difference demonstrated by Mx suggests that the asymmetric chelants provide more polarizable environments compared to DME. In general, the less compact and more polarizable solvation sheath reduces the λ for electron transfer, which reduces overpotential effectively by preventing electrolyte decomposition and promoting stable Mg plating and stripping.

In addition to the λ, substantial differences were observed for the initial Mg²⁺/Mg⁺ reduction potentials for the Mg²⁺(M4)₃ and Mg²⁺(DME)₃ solvates, with Mg²⁺/Mg⁺ reduction most readily occurring in Mg²⁺(M4)₃, while reduction of Mg²⁺(DME)₃ requiring much larger overpotential by 0.4-0.6 V. An intermediate reduction potential is observed for Mg²⁺(M1)(DME) that is consistent with the intermediate performance of E1 electrolyte (FIGS. 3A, 3B, and 4). The larger overpotential to initiate electron transfer in blank likely contributes to the slower interfacial kinetics and electrolyte decomposition. Because MgO is often present on Mg metal, solvent reactivity with MgO was examined in DFT calculations that the defect-free surfaces are not reactive towards DME or chelants.

### Solvation Sheath Mediated Charge Transfer in Layered Oxide Cathode

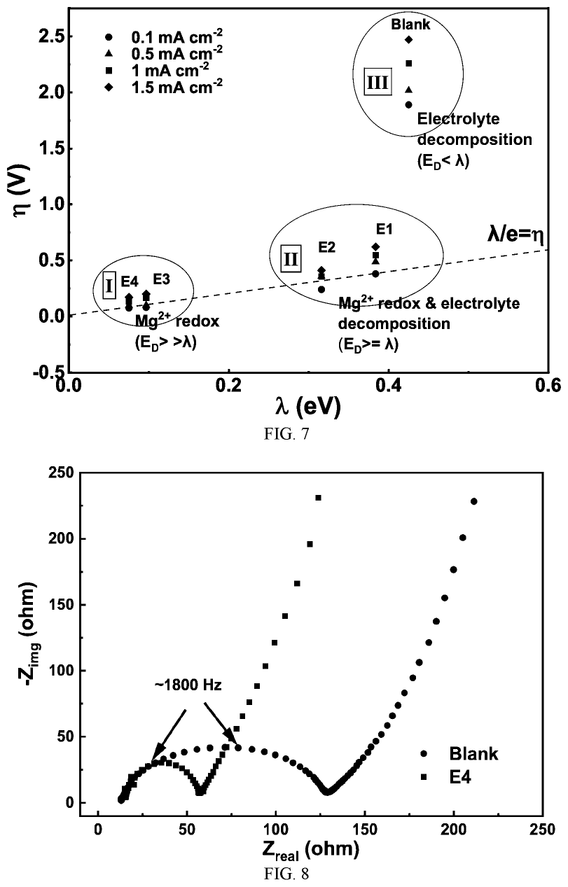

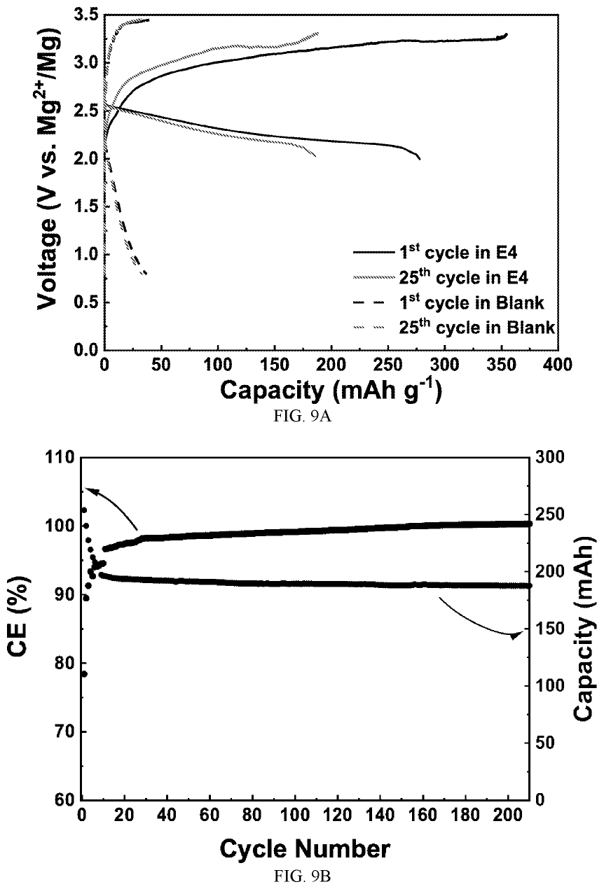

On the anode, the solvation sheath reorganized to the activated state at which the electron transfer occurred. In an oxide cathode, however, the ion accepts an electron indirectly through concerted intercalation near the transitional metal center, yet we found that the Mx in an electrolyte can also significantly improve the charge transfer kinetics on the cathode. Mg pillared layered MnO₂ (Mg_{0.15}MnO₂) was used as cathode material and E4 was used to evaluate the electrochemical performance of the Mg∥Mg_{0.15}MnO₂ cell due to its higher anodic stability (3.8 V vs. Mg²⁺/Mg). Mg∥Mg_{0.15}MnO₂ cell was charged/discharged between 2 to 3.3 V (versus Mg²⁺/Mg) at 0.5 C (1C corresponds to a 200 mA g⁻¹ active material) and a reversible capacity of 190 mAh g⁻¹ was achieved and maintained for 200 cycles. FIGS. 9A and 9B. Contrary to the performance in E4, the charge/discharge of Mg∥Mg_{0.15}MnO₂ cell in blank showed little capacity at the same C-rate (FIG. 9A). Charge transfer resistances (R_{ct}) of the Mg_{0.15}MnO₂ cathode in blank and E4 were measured using electrochemical impedance spectroscopy (EIS) in a three-electrode cell with magnesiated Mo₆S₈ reference electrodes (FIG. 8) to exclude potential variation from the reference. The charge transfer processes of the Mg_{0.15}MnO₂ cathode in E4 and blank are represented by the semi-circles in the EIS spectra with similar characteristic frequencies. The values of R_{ct} determined by the diameter of the semi-circle is two to three times smaller in E4 than that in blank (FIG. 8), suggesting a much faster charge transfer kinetics.

The Mg_{0.15}MnO₂ cathode was further characterized to identify the cause of faster charge transfer kinetics in E4. The reversible electron transfer to the Mg_{0.15}MnO₂ cathode was demonstrated by manganese (Mn) 2p 3/2 HRXPS spectra, in which the peaks associated with Mn⁴⁺ reduced and those peaks associated with Mn³⁺ and Mn²⁺ intensified. A shake-up satellite characteristic of Mn²⁺ also appeared after discharge. The change of the Mn oxidation states was reversed after charge and the pristine state was regenerated. Concerted with the electron transfer is the Mg²⁺ (de)intercalation, demonstrated firstly by reversible incorporation and extraction of 0.3 Mg²⁺ to the cathode after discharge and charge measured by inductively coupled plasma optical emission spectroscopy. Since the number of Mg²⁺ incorporated or extracted is in accord with the coulombic capacity (FIG. 8), Mg²⁺ is the only ion that participated in the redox reaction. Unlike Mo₆S₈ and TiS₂, which demonstrate very little change of lattice indexes upon Mg²⁺ (de)intercalation, a significant enlargement of the interlayer distance was observed after discharging the cathode in E4, suggesting that larger species were intercalated with Mg²⁺. The species were then extracted from the oxide cathode together with Mg²⁺ after the charge and the interlayer distance were reduced. The elemental distribution of the discharged cathode from energy-dispersive X-ray spectroscopy (EDX) demonstrated the presence of C and N in the materials together with Mg²⁺, in combination with the characteristic peaks for M4 observed in the attenuated total reflectance Fourier-transform Infrared spectrum in the discharge cathode, confirming the presence of M4 when electron is transferred to the Mg²⁺ intercalated cathode. The fact that M4 in the solvation sheath significantly facilitates the charge transfer kinetics of cathode suggests that solvation sheath reorganization also occurred in the cathode and limits the interfacial charge transfer reaction kinetics.

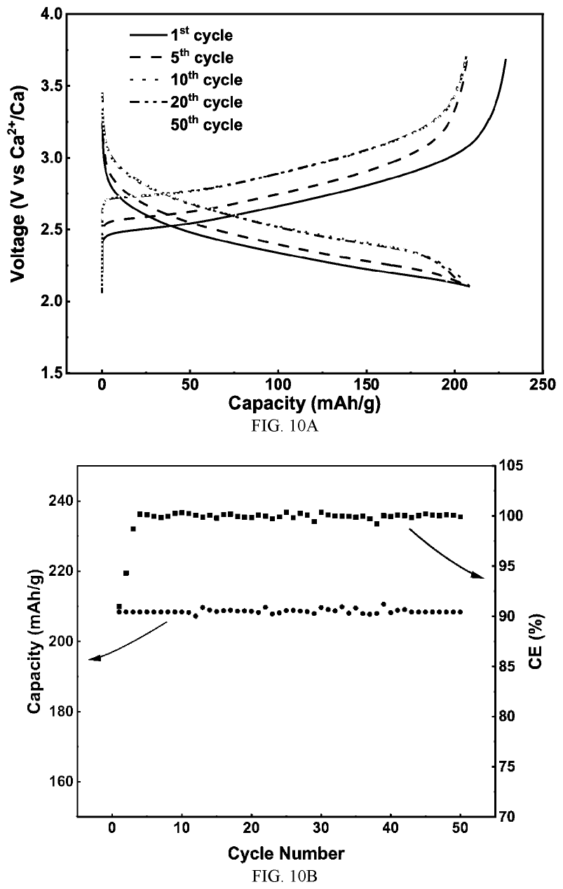

The generality of the electrolyte design is demonstrated in other solvents used in RMBs such as diglyme and tetrahydrofuran. Extension to RCBs was validated by adding M4B to 0.5 M calcium tetrabis(hexafluoroisopropyloxy)borate-DME, in which the Ca²⁺ deposition and stripping cCE increases from 80% to 96%. M4B (i.e., CH₃O(CH₂)₂CH(CH₃)NH₂) is a derivative of M4 with an extra methylene carbon to accommodate the larger size of Ca²⁺. This electrolyte was used to pair the Ca metal anode with Mg_{0.15}MnO₂ full cell and demonstrates a 2.6 V average potential with a reversible capacity of 210 mAh g⁻¹ at 0.5 C for 50 cycles. FIGS. 10A and 10B.

The present disclosure has identified several factors needed for the cation solvation sheath to successfully undergo the reorganization for a fast Mg²⁺/Mg redox reaction, including the: (1) solvation free energy for Mg²⁺ serving as a descriptor for salt dissociation, (2) reduction potential for the Mg²⁺(solvent)ₙ->Mg⁺(solvent)ₙ reaction to ensure that the Mg²⁺/Mg redox occurs within electrolyte cathodic stability window, and (3) reorganization free energy (λ). Other multidentate compounds were explored using DFT and validated with cycling tests. Ethylenediamine was also found to be useful as a multidentate compound or as a solvent due to high free energy of solvation, high reduction potential for Mg²⁺, and low λ.

Electrolytes comprising a multidentate compound (e.g., methoxyethyl-amine) overcome many of the problems associated with rechargeable divalent metal batteries, such as high interfacial impedance and overpotentials for plating/stripping divalent metal anodes, e.g., Mg and Ca. Surprisingly and unexpectedly, it was discovered that the addition of multidentate compounds in electrolytes of rechargeable divalent metal batteries allows preferential solvation of metal cations and facilitates the initial reduction step. Thus, adding a multidentate compound to the electrolyte of rechargeable divalent metal batteries solved some of the key problems associated with conventional divalent metal batteries, such as the low reversibility for anodes and sluggish kinetics of metal-oxide cathodes, which enable the energy density of rechargeable divalent metal batteries, such as RMBs and RCBs, to be comparable to LIBs. The reorganization energy can be tuned or modified by tailoring the multidentate compound, e.g., by introducing heterogeneous donor atoms and less compact structures, to further enhance the kinetics and reversibility.

Additional objects, advantages, and novel features of this disclosure will become apparent to those skilled in the art upon examination of the following examples thereof, which are not intended to be limiting. In the Examples, procedures that are constructively reduced to practice are described in the present tense, and procedures that have been carried out in the laboratory are set forth in the past tense.

### Examples

### Chemicals and Synthesis

Mg(TFSI)₂ (99.5%, Solvionic) was dried at 200° C. under vacuum for 24 hours before use. 1,2-Dimethoxyethane (DME, anhydrous and inhibitors free 99.5%, Sigma-Aldrich), tetrahydrofuran (THF, anhydrous and inhibitors free 99.9%, Sigma-Aldrich), diethylene glycol dimethyl ether (diglyme or G2, anhydrous 99.5%, Sigma-Aldrich), bis(2-methoxyethyl)amine (M2, 98%, Sigma-Aldrich), 2-methoxyethylamine (M3, 99%, Sigma-Aldrich) and 1-methoxy-2-propylamine (M4, 99%, Sigma-Aldrich), were dried overnight with 4 Å molecular sieves (Sigma Aldrich) and stored in the glove box. Diaza-18-crown-6 (M1, 98%, Acros Organics) was recrystallized in anhydrous acetonitrile solution with hexane as antisolvent, then dried in vacuum at 80° C. overnight. The Mg(TFSI)₂ electrolytes were prepared by dissolving dried Mg(TFSI)₂ into DME or DME-Mx mixture to form a 0.5 M solution. The compositions of DME-Mx mixture were DME/M1=4.0/1 (w/w), DME/M2=3.9/1 (w/w), DME/M3=4.7/1 (w/w) and DME/M4=3.84/1 (w/w). When DME was replaced with THF, the compositions of THF-Mx mixture were THF/M1=4.0/1 (w/w), THF/M2=4.0/1 (w/w), THF/M3=4.89/1 (w/w) and THF/M4=3.94/1 (w/w). When DME was replaced with G2, the compositions of G2-Mx mixture were G2/M1=4.31/1 (w/w), G2/M2=4.25/1 (w/w), G2/M3=5.17/1 (w/w), G2/M4=4.16/1 (w/w). The Ca[B(hfip)₄]₂ salt was synthesized by adding 10 equivalents of hexafluoroisopropanol (99.5%, Sigma Aldrich) dropwise to the suspension of Ca(BH₄)₂ (0.5 g, 2.33 mmol Ca(BH₄)₂·2THF, >99%, Sigma Aldrich) in 10 mL THF then stirred overnight at 40° C. under the protection of inert gas (Ar or N₂). The final products were precipitated, recrystallized, and washed by anhydrous hexane (99%, Sigma-Aldrich). The salt crystal was then dried under vacuum at 60° C. for 24 hours before use. The final product was confirmed by single peak at the m/z=678.9 Da in the m/z range of 50 to 1000 with electrospray ionization-time of flight mass spectrometry (AccuTOF, JOEL, USA, Inc.). The water content of all electrolytes was determined with Karl-Fischer titration and controlled to be under 10 ppm for all cell assemblies.

The following Mg_{0.15}MnO₂ synthesis procedure was used. NaₓMnO₂ was first synthesized by heating 2 g of Mn₂O₃ (99.9%, Sigma Aldrich) in 40 mL of 10 M NaOH aqueous solution at 170° C. for 72 hours in a Teflon-lined autoclave. The product was washed with distilled water repeatedly until the pH of rinsing solution was around 7 to 8, and the layered structure was confirmed with x-ray powder diffraction. The NaₓMnO₂ was then ion exchange in a 1 M Mg(NO₃)₂ water solution for 24 hours to obtain Mg_{0.15}MnO₂. The material was then dried under vacuum at 150° C. for 3 days to remove surface and lattice water. The Mg and Na content in the final product was determined by Inductively coupled plasma-optical emission spectrometry (ICP-OES). The cathode slurry was made by mixing 0.45 g Mg_{0.15}MnO₂ with 0.025 g carbon black (Timcal Super C65, Imerys) and 0.5 g 5 wt % polyvinylidene fluoride in 1-methyl-2-pyrrolidinone (NMP; 99.5%, Sigma Aldrich). The slurry was then casted onto aluminum foils with a doctor blade and dried in room temperature overnight then under vacuum at 100° C. for 24 hours to completely remove the residual solvent. The areal loading of the cathode material was around 3 mg cm⁻².

### Electrochemical Tests

All cell tests were conducted in CR2032 coin cells on BT 2000 battery test station (Arbin Instruments), unless stated otherwise. Mg stripping or plating was tested in Mg∥Mg symmetric cells or Mg∥stainless stain (304 SS, Trinity Brand Industries) cells with two pieces of 25 μm PP/PE/PP tri-layered separators (2325, Celgard). Stainless steel (SS) was chosen as anode current collector to avoid alloy formation with Mg or Ca. The Mg foil (0.1 mm thick, 99.9%, MTI Corporation) and 304 SS shim were sanded in the glove box with 2000 grit sandpaper (Wetordry, 3M) and wiped with hexane (anhydrous >=99%, Sigma Aldrich). Ca pellets were prepared by pressing the granular Ca (99%, Sigma Aldrich) with a hydraulic press and shaped with cutting punches; the prepared Ca pellets were sanded in the glove box. Ca stripping/deposition was tested in a Ca∥SS using glass microfiber separators (GF/F, Whatman). The full cell tests were performed by pairing the dried cathodes with Mg foils or Ca pellets.

The three-electrode electrochemical impedance tests were conducted in T-cell (Swagelok) with Mg foil as counter and reference electrode, and Mg_{0.15}MnO₂ as working electrode on a Gamry interface 1000E potentiostat from 10⁶ Hz to 0.1 Hz with AC oscillating of 10 mV.

### Material Characterization

HRXPS data were collected with a Kratos Axis 165 spectrometer operating in hybrid mode, using monochomatized Al Kα X-rays (1486.7 eV). Survey and high-resolution spectra were collected with pass energies of 160 and 40 eV, respectively. Mg⁰ (49.6 eV) was used as the reference to calibrate all the spectra. Peak fitting was performed on CASA XPS software. Data were processed with Shirley backgrounds, and a 30% Lorentzian, 70% Gaussian product function was used for peak fitting. S 2p spectra were fitted with spin-orbit split 2p 3/2 and 2p 1/2 doublets with a 1.16-eV peak separation and 0.6667 area ratio. The Mn 2p 3/2 spectra fitting was constrained by the full width at half maximum. The ¹³C NMR experiments were performed at 25° C. on a Bruker DRX 500-MHz NMR without using deuterated solvent, 1 vol % tetramethylsilane (>99%, Sigma Aldrich) was added to the electrolytes and the corresponding ¹³C chemical shift set to zero ppm as internal reference for all spectra. Raman spectra were collected on a Horiba Jobin Yvon Labram Aramis Raman microscopy using a 633 nm helium neon laser between 1200 and 300 cm⁻¹, with all the samples sealed in test glass vials. Laser power was set at 150˜450 mV, and 400 scans were accumulated with resolution of 2 cm⁻¹. STEM and EDX mapping were performed on a JEM 2100F Field emission-TEM microscope at 100 kV SEM was performed with Hitachi S-4700 operating at 10 kV.

### Molecular Dynamic Studies of Mg(TFSI)₂/DME-Mx Electrolytes

All the classic molecular dynamic (cMD) simulations were performed using the Large-scale Atomic/Molecular Massively Parallel Simulator (LAMMPS, lammps.sandia.gov). The compositions of electrolytes were 125 Mg(TFSI)₂, 2151 DME, 165 M1 in E1; 125 Mg(TFSI)2, 2036 DME, 334 M2 in E2; 125 Mg(TFSI)2, 1792 DME, 539 M3 in E3; and 125 Mg(TFSI)2, 1792 DME, 468 M4 in E4. OPLS-AA parameters with 1.14*CM1A partial atomic charges were generated by LigParGen for the DME and Mx solvent molecules. The charges and force field for TFSI anions in the electrolytes were taken from J. Phys. Chem. B, 111, 4867-4876 (2007). The OPLSAA force field developed by Jorgensen (see J. Chem. Phys. 100, 9050-9063 (1994)) was used for Mg²⁺ ions. The Lennard-Jones (LJ) parameters for Mg—N(TFSI), Mg—F(TFSI), and Mg—O(TFSI) pairs are taken from the work on Mg(TFSI)₂ solution in DME. See ACS Omega, 5, 12842-12852 (2020). For different kinds of atoms, the Lorentz-Berthelot combination rule was employed to obtain their LJ interactions. The MD simulations were performed in the isothermalisobaric (NPT) ensemble at p=1 atm and T=298 K with a Nose-Hoover barostat and thermostat for 5 ns with a time step of 1.0 fs to integrate the equations of motion. Periodic boundary conditions were used, and electrostatic interactions were considered using the particle-particle particle-mesh scheme in the k-space. The NPT calculated densities are in good agreement with the experimentally measured densities at room temperature (less than 10% deviation). Subsequently, 10 ns equilibration MD runs were performed in the canonical (NVT) ensemble, followed by 10 ns NVT production runs that were used to extract structural properties.

### Quantum Chemistry Calculations of the Solvate Binding Energies and Reduction Potentials

Quantum chemistry calculations were performed using Gaussian 16 software package. Gaussian, Inc., Wallingford CT, 2016. (2016). Geometry optimizations and energy calculations were performed using B3LYP/6-311G(d,p) and M05-2X/6-31+G(d,p) DFT. Ability of DFT calculations to accurately predict solvate binding energy and free energies was checked by comparison with the computationally expensive but more reliable benchmark G4MP2 calculations. The PCM continuum solvation model was used to implicitly represent solvent beyond the first solvation shell. Two implicit solvents were used: 1) 1,1,2-trichloroethane (ε=7.19), which has dielectric constant very similar to the value of DME solvent and ether (ε=4.24) to account for the reduced dielectric constant near the electrodes and with addition of co-solvents that have lower dielectric constant.

The binding energies (G_{b}) of solvation structure are calculated as:

$${G}_{b} = \sum {G}_{m} - {G}_{cluster}$$

where ΣGₘ is the sum of free energies of all molecules and Mg-ion forming the solvation structure and the G_{cluster} is the free energies of the corresponding solvation structure. Here, a more positive binding energy indicates a more stable solvation structure. Visualization of the structures are made by using VESTA software (J. Appl. Crystallogr. 44, 1272-1276 (2011)) and jmol software.

The reduction potential E_{red} for the Mg solvates denoted as complex A was calculated as the negative of the energy or free energy of formation of A⁻ in solution [ΔG_{S}=G_{S}(A⁻)-G_{S}(A)] divided by Faraday's constant as given by:

$${E}^{r e d} = - \frac{Δ {G}_{298 K}^{s}}{F} - 2.06 V$$

2.06 V converts from the absolute potential to vs. Mg.

Three different density functionals M05-2X, wB97xD and CAM-B3LYP and two different basis sets 6-31+G(d,p) and aug-cc-pvTz were also used in select calculations to confirm that the DME containing Mg²⁺ solvates such as Mg²⁺(DME)₃ have much lower reduction energy for the initial Mg²⁺/Mg⁺ reduction than Mg²⁺(M4). Thus, this conclusion holds for all investigated density functionals and basis sets.

The reorganization energy (λ) was calculated as the average of the reorganization energy from the reactant potential energy surface and one on the product potential energy surface.

### Illustrations and Description

The ionic conductivities of electrolytes are measured with electrochemical impedance at 25° C. using two stainless steel blocking electrodes. The first intercepts with x-axis in Nyquist plots were used to calculate the resistances of the ion conduction in the electrolytes. The ionic conductivities are calculated using equation S1, in which the resistances of the Eₓ were compared to that of a standard electrolyte with a known ionic conductivity at 25° C. Here, 1.0 M LiPF₆ in ethylene carbonate/diethyl carbonate (EC/DEC, v/v=1/1) with ionic conductivity of 8 mS cm⁻¹ was used as the standard electrolyte in all ionic conductivity measurements.

$$ionic conductivity of Ex = \frac{Resistance of standard}{Resistance of Ex} \times ionic conductivity of standard \qquad ( S1 )$$

Several factors were identified that are essential for solvation sheath to successfully undergo the reorganization process for fast Mg²⁺/Mg redox reaction, including: (1) solvation free energy (ΔG^{solv}) for Mg²⁺, serving as a descriptor for salt dissociation, (2) reduction potential (E^{red}) for the Mg²⁺(solvent)ₙ->Mg⁺(solvent)ₙ reaction to ensure Mg²⁺/Mg redox occur within electrolyte cathodic stability window, and (3) reorganization free energy (λ). DFT calculations were used to assist in selecting new solvents based upon these factors. Molecules that are structural variations to Mx were also tested. M1B (18-crown-6 ether) changes the N donor to O donor in M1, M5 (methoxymethyl amine) changes the carbon linker between donor atoms in M3, M6 (ethylene diamine) changes the O donor atoms to N in M3, and M6B (N,N,N,N-tetramethylethylene diamine) substitutes H on N with two bulkier —CH₃.

DFT results indicate that Mg²⁺(DME)₃ and Mg²⁺(M1B)₃ crown ether have the lowest E^{red} (more negative than −0.6 V), thus are expected to require large overpotentials for Mg²⁺ reduction that results in the solvent/anion decomposition. The solvate with M5 has higher ΔG^{solv} than Mg²⁺(DME)₃ indicating that a higher percentage of the contact ion pairs of Mg-TFSI are likely to form leading to TFSI⁻ reduction and electrolyte decomposition. Usage of M6 results in E^{red} around −0.1 V, low λ and higher free energy of solvation than Mg²⁺(DME)₃ (ΔG^{solv}>0) making it a promising solvent for Mg plating. Usage of M6B solvent yields intermediate E^{red} and λ suggesting that the Mg²⁺/Mg reduction is expected to be sluggish. The picture created by these three DFT descriptors is in good agreement with the cycling results for the Mg∥Mg coin cell.

Hydrogen transfer from the methoxyethyl amines to oxide surface is energetically unfavorable due to the dangling oxygen at the edge of MgO. The transfer of hydrogen potentially generates the Mg(OH)₂ that is sparingly soluble in the Mx-DME mixture from Inductively Coupled Plasma-Optical Emission Spectroscopy (ICP-OES) measurements. Yet no magnesium dissolution detected from measurements when submerging the Mg powder in Mx-DME mixture, thus the hydrogen transfer reaction to the dangling oxygen on MgO is considered not observable. Similarly, the cleavage of C—O in DME or Mx could only happen on the dangling oxygens at the edge of MgO, other sites are unfavorable.

EIS tests were performed using magnesiated Mo₆S₈ as a reference electrode since it operates within the stability window of the electrolytes and has stable potential. The Cu₂Mo₆S₈ was first synthesized through element reaction at 900° C. and then the copper was leached in HCl solution with the aid of air bubbles to make Mo₆S₈ (59). The electrode was made by mixing 80 wt % Mo₆S₈ with 10 wt % conductive carbon and 10 wt % polyvinylidene fluoride binder. An activation cycle was performed at 0.05C (1C=discharge in 1 hour) in E4, followed by capacity control discharge to the second plateau so that the magnesiated Mo₆S₈ electrodes maintain stable voltage when used as reference electrodes. The potential of magnesiated Mo₆S₈ is 1.0 V vs Mg²⁺/Mg and is within the stability window of the electrolytes. The magnesiated Mo₆S₈ electrodes were then rinsed in DME to remove residual electrolyte before assembled into 3-electrode cells for EIS measurements.

The attenuated total reflectance (ATR) Fourier-transform infrared absorption spectra (FT-IR) of DME, M4, E4, the Mg_{0.15}MnO₂ before discharge, and after discharge were obtained. The spectra were taken on a Thermo Nicolet NEXUS 670 FTIR between 600 to 4000 cm⁻¹ with a deuterated triglycine sulfate detector, a resolution of 4 cm⁻¹, and a 16-scan average. The Mg_{0.15}MnO₂ before discharge demonstrates nominal adsorption pattern at the IR range, but several characteristic peaks of M4 show after discharge, including the doublet around 3380 and 3300 cm⁻¹ corresponding to the in-phase and out-of-phase stretching of —NH₂, the single peak at around 1600 cm⁻¹ corresponding to the —NH₂ bending, the doublet at 1400 and 1350 cm⁻¹ with shoulder peaks at 1300 cm⁻¹ corresponding to the bending of the —CH— next to —NH₂ that is split by the neighboring —CH₃ and —CH₂—, the double peak between 1100 and 1200 cm⁻¹ corresponding to the C—N stretching, and the peak group between 700 and 900 cm⁻¹ corresponding to the wagging of —NH₂. While the characteristic peaks for M4 are abundant, the characteristic peaks for DME such as the single peak at 1000 cm⁻¹ and 800 cm⁻¹, and the characteristic peaks for TFSI⁻ such as the shoulder peak around 1000 cm⁻¹ and the peak group near 600 cm⁻¹ were not identified, further confirming that it is M4 and not DME nor TFSI⁻ participating in the cathode reaction.

### Relative Affinity Determined by ¹³C NMR

The observed chemical shift (δ^{obs}) for methylene carbons in DME and Mx in the electrolytes is the molar average of the chemical shifts of free (δ^{free}) and bound states (δ^{bound}) of these molecules as described in equation (S3), in which y represents the molar percentage at bound state:

$${δ}^{obs} = {δ}^{bound} \times y + {δ}^{free} \times ( 1 - y ) \qquad ( S3 )$$

Therefore, y for DME or Mx can be determined by

$$y = \frac{( {δ}^{obs} - {δ}^{free} )}{( {δ}^{bound} - {δ}^{free} )} \qquad ( S4 )$$

δ^{bound}−δ^{free} for DME and Mx are the same due to structure similarity, the value of δ^{bound} for DME was obtained from NMR spectrum of DME-Mg(TFSI)₂ saturated solution to be 63.4 ppm and the δ^{free} from the salt free DME to be 71.3 ppm. Thus, y for DME in the blank electrolyte is 0.0519 according to equation (S4). When this method is used to determine the y for Mx, an average (δ^{obs}−δ^{free}) from methylene carbon near oxygen and nitrogen was used. The relative affinity of Mx over DME is defined as the affinity coefficient for Mg²⁺-Mx interaction divided by that for Mg²⁺-DME interaction, which can be calculated from equation (S5) and tabulated in Table 3:

$$Relative affinity = \frac{[ Mg - {M}_{x} ]}{[ {Mg}^{2 +} ] [ {M}_{x} ]} \times \frac{[ {Mg}^{2 +} ] [ DME ]}{[ Mg - DME ]} = \frac{{y}_{Mx} \times ( 1 - {y}_{DME} )}{{y}_{DME} \times ( 1 - {y}_{Mx} )} \qquad ( S5 )$$

CIP Percentages in Electrolyte with Raman Spectroscopy

TFSI⁻ in solvent separated ion pairs (SSIPs) and contact ion pairs (CIPs) showed distinct Raman shift for the S—N stretch vibration, with the CIP peaks located closer to the crystal ion pair peak from pure Mg(TFSI)₂ powder. The two peaks are deconvoluted with peak fitting using a Pseudo-Voigt function with 60% Gaussian and 40% Lorentzian, the FWHM for SSIP and CIP peaks are constrained to be the same for all samples. The position of S—N in SSIPs was fixed to be 740.7 cm⁻¹ and FWHM to be 5. The CIP peaks were obtained through peak fitting. The CIP percentage is determined by the ratio between CIP peak areas versus total peak areas. The peak fit was verified by the increase of CIP percentage when increasing Mg(TFSI)₂ concentration in DME.

### Reciprocal of Distance Between Solvated Ion and Electrode (1/R)

The solvated ion-electrode distances (R) were determined on Mg after ten cycles in blank electrolyte or Eₓ using Ga⁺ Focused Ion Beam/Scanning Electron Microscopy with TOF-SIMS (Tescan GAIA 3), the accelerate voltage is 20 kV. Since O and F are major compositions that potentially block the contact between Mg²⁺ and the electrode surface, the negative mode was adapted in TOF-SIMS to monitor O⁻ and F⁻ signals distribution at different sputtering depths. With the total sputtering depth being measured using SEM, the average sputtering depth from each frame can be determined. The monotonic O⁻ (m/z=−16) and F⁻ (m/z=−19) depth profiles indicate the absence of multi-layer structure on the cycled Mg. Due to the inhomogeneous distribution of O and F, the solvated ion-electrode distances, R, were defined at the frame when the F-free and O-free area rose to over 50% of the total inspected surface. The solvated ion-electrode distance, R, is the multiplication between designated frame number and the average sputtering depth from one frame. The values of 1/R in different electrolytes determined here are tabulated in Table 5.

TABLE 5
The reciprocal of surface film thickness (1/R) obtained
by measuring the distance between the solvated ion and
Mg electrode (R) after ten cycles in blank electrolyte or
Eₓ using Time-of-Flight Secondary Ion Mass Spectrometry
(TOF-SIMS). See “Reciprocal of distance between solvated
ion and electrode (1/R)” in Supplementary Text for details.

| Electrolyte | 1/R (nm⁻¹) |
|---|---|
| Blank | 0.00684 |
| E1 | 0.0397 |
| E2 | 0.0578 |
| E3 | >0.111 |
| E4 | >0.125 |

The foregoing discussion of the subject matter of the present disclosure has been presented for purposes of illustration and description. The foregoing is not intended to limit the scope of the present disclosure to the form or forms disclosed herein. Although the description of the subject matter of the present disclosure includes the description of one or more embodiments and certain variations and modifications, other variations and modifications are within the scope of the present disclosure, e.g., as may be within the skill and knowledge of those in the art, after understanding the present disclosure. It is intended to obtain rights, which include alternative embodiments to the extent permitted, including alternate, interchangeable, and/or equivalent structures, functions, ranges or steps to those claimed, whether or not such alternate, interchangeable, and/or equivalent structures, functions, ranges or steps are disclosed herein, and without intending to publicly dedicate any patentable subject matter. All references cited herein are incorporated by reference in their entirety.

1-42. (canceled)

43. A rechargeable battery comprising:
a cathode;
an anode comprising a divalent metal; and
an electrolyte composition comprising a solvent, an electrolytic salt, and a multidentate compound.

44. The rechargeable battery of claim 43, wherein said divalent metal comprises Mg, Ca, Zn, or a combination thereof, or an alloy thereof.

45. The rechargeable battery of claim 43, wherein said cathode comprises sulfur, a metal oxide, or a combination thereof.

46. The rechargeable battery of claim 43, wherein said cathode comprises sulfur, Mo₆S₈, graphite-like MoS₂, TiS₂, FeS, vanadium sulfide (VS), magnesium-manganese oxides, Chevrel phase MxMo₃T₄, wherein M is a metal, x an integer that depends on the oxidation state of M, and T is S or Se, mesoporous Mg_{1.03}Mn_{0.97}SiO₄, manganese oxide, layered vanadium pentoxide, VO₂, LiMn₂O₄, magnesium-manganese oxide, NiO₂, CoO₂, or a combination thereof.

47. The rechargeable battery of claim 43, wherein said multidentate compound comprises a linear or branched non-cyclic multidentate compound having at least one oxygen atom and at least one nitrogen atom.

48. The rechargeable battery of claim 47, wherein said linear or branched non-cyclic multidentate compound is of the formula:
X¹—(R—X²)_{q}—R—X³
wherein
q is an integer from 0 to 10;
each R is independently a cycloalkylene, C₁-C₆ linear or branched alkylene, or C₁-C₆ linear or branched haloalkylene;
each of X¹, X², and X³ is independently —OR¹ or —NR²R³, provided at least one of X¹, X², and X³ is —OR¹ and at least one of X¹, X², and X³ is —NR²R³;
R¹ is alkyl or haloalkyl; and
each of R², and R³ is independently H, alkyl or haloalkyl.

49. The rechargeable battery of claim 48, wherein q is 1.

50. The rechargeable battery of claim 48, wherein R is C₁₋₆ linear or branched alkylene or C₁₋₆ linear or branched haloalkylene.

51. The rechargeable battery of claim 43, wherein a ratio of said solvent to said multidentate compound is ranges from about 1:1 to about 5:1 by weight.

52. A rechargeable battery having an energy density of at least about 400 Wh kg⁻¹ and an average coulombic efficiency of at least 80%, wherein said rechargeable battery comprises an anode comprising a divalent metal.

53. The rechargeable battery of claim 52, wherein said rechargeable battery comprises an electrolyte comprising a solvent, an electrolyte salt, and a multidentate compound.

54. The rechargeable battery of claim 53, wherein said multidentate compound comprises (i) a cyclic multidentate compound having at least one oxygen and at least one nitrogen ring atoms or (ii) a linear or branched non-cyclic multidentate compound having at least one oxygen and at least one nitrogen atoms.

55. The rechargeable battery of claim 54, wherein said linear or branched non-cyclic multidentate compound is of the formula:
X¹—(R—X²)_{q}—R—X³
wherein
q is an integer from 0 to 10;
each R is independently a cycloalkylene, C₁-C₆ linear or branched alkylene, or C₁-C₆ linear or branched haloalkylene;
each of X¹, X², and X³ is independently —OR¹ or —NR²R³, provided at least one of X¹, X², and X³ is —OR¹ and at least one of X¹, X², and X³ is —NR²R³;
R¹ is alkyl or haloalkyl; and
each of R², and R³ is independently H, alkyl or haloalkyl.

56. The rechargeable battery of claim 52, wherein said divalent metal is selected from the group consisting of Mg, Ca, Zn, or a mixture thereof, or an alloy thereof.

57. The rechargeable battery of claim 52, wherein said rechargeable metal battery is a solid-state battery.

58. A method for reducing an anode charge transfer overpotential for a divalent metal anode in a rechargeable metal battery, said method comprising adding a multidentate compound to an electrolyte of said rechargeable metal battery.

59. The method of claim 58, wherein said divalent metal anode comprises a divalent metal selected from the group consisting of Mg, Ca, Zn, or a mixture thereof, or an alloy thereof.

60. The method of claim 58, wherein said multidentate compound comprises (i) a cyclic multidentate compound having at least one oxygen and at least one nitrogen ring atoms or (ii) a linear or branched non-cyclic multidentate compound having at least one oxygen and at least one nitrogen atoms.

61. The method of claim 58, wherein said linear or branched non-cyclic multidentate compound is of the formula:
X¹—(R—X²)_{q}—R—X³
wherein
q is an integer from 0 to 10;
each R is independently a cycloalkylene, C₁-C₆ linear or branched alkylene, or C₁-C₆ linear or branched haloalkylene;
each of X¹, X², and X³ is independently —OR¹ or —NR²R³, provided at least one of X¹, X², and X³ is —OR¹ and at least one of X¹, X², and X³ is —NR²R³;
R¹ is alkyl or haloalkyl; and
each of R², and R³ is independently H, alkyl or haloalkyl.

62. The method of claim 61, wherein R is C₁₋₆ linear or branched alkylene or C₁₋₆ linear or branched haloalkylene.
